(19) United States
(12) Patent Application Publication
(10) Pub. No.: US 2020/0034777 A1
(43) Pub. Date: Jan. 30, 2020

(54) System and Method for Identifying Top Performing Individuals Offering Services in a Given Profession

(71) Applicants: John P. Amato, Scotch Plains, NJ (US); Frank S. Ciminello, Scotch Plains, NJ (US)

(72) Inventors: John P. Amato, Scotch Plains, NJ (US); Frank S. Ciminello, Scotch Plains, NJ (US)

(21) Appl. No.: 16/523,256

(22) Filed: Jul. 26, 2019

Related U.S. Application Data
(60) Provisional application No. 62/711,059, filed on Jul. 27, 2018.

(51) Int. Cl. G06Q 10/06

(52) U.S. Cl. CPC G06Q 10/063112

(57) ABSTRACT

The present invention is directed to a system and method for identifying top performing individuals who offer specialized services within a given professional field based on evaluations of the skill, training, background, and professional assessment of qualifying individuals. In one embodiment of the invention, a solicitation board is formed to solicit nominees working within a given field relative to pre-determined criteria. The criteria comprise a non-exhaustive list of attributes by which a hypothetical professional is measured for purposes of determining a top performer. Criteria is used to form a first tier of candidates, who are assessed by the solicitation board to form a second tier of candidates. A review board will successively review information associated with candidates of the second tier, to create subsequent tiers of candidates who are considered as among a top tier of professionals within a locale. In an alternative embodiment, the method of the present invention will include a consideration of surveys from third parties who have first-hand knowledge of the implementation and use of a given candidate's education, training and skills in their chosen profession. The present invention provides a 360 degree evaluation of the professionals considered as forming the top tier of comparable professionals.

### CROSS REFERENCE TO RELATED APPLICATION

This application claims priority from U.S. provisional application Ser. No. 62/711,059, filed Jul. 27, 2018.

### FIELD OF THE INVENTION

The present invention relates to the field of performance evaluations. More particularly, the present invention relates to a system and method for identifying top performing individuals who offer specialized services within a given professional field based on evaluations of the skill, training, background, and professional assessment of qualifying individuals.

### BACKGROUND OF THE INVENTION

From time-to-time individuals encounter circumstances in which services of licensed professionals are required. Licensed professionals include, but are not limited to, doctors, lawyers, nurse practitioners, accountants, engineers, and other types of professionals who are licensed by a governing board or a governmental unit. These types of professionals are typically qualified based on their training, education, and score in completing one or more entrance examines. After becoming licensed, the professionals offer their services to members of the public relative to the field in which they will work.

For members of the public at large, the act of selecting the best qualified and experienced professional can be a challenge. For instance, in the medical profession, there are hundreds of thousands of physicians who practice a wide range of medical disciplines or specialties. Over 120 specialties and subspecialties exist in the field of medicine from which a person can choose a physician ranging from internal medicine, pediatric, neurology, plastic surgery, endocrinology, cardiovascular surgery, and many more. As of 2016, there were more than 950,000 physicians with an active license to practice medicine in the United States and the District of Columbia. For members of the public who are interested in using the services of a physician there are many from which to choose, but determining who is the best qualified and experienced physician with successful outcomes is a challenge due to the number of choices and the difficulty obtaining an honest assessment of the physician's skills and training.

Assessing the skills and training of professionals, such as a physician, is often a tedious chore. Many members of the public lack the personal skill, training, and experience to select one professional from another. Often times, individuals select a particular professional based on word of mouth, the reputation of the professional, or by referrals from other professionals. Making the right choice is tedious because the individual often does not know who to believe or what information is reliable. Questions such as the number of years of practice, the number of surgeries performed, and who is considered the foremost physician in the field are questions that are weighed by individuals when deciding to use the services of one physician versus another physician.

To navigate the selection of professionals working in a given professional field, individuals will resort to performing their own research. In the context of the medical field, it is not uncommon for individuals to sit at their desk at home or at work, access the Internet via computer, and use a search engine, such as Yahoo®, to enter a query: “who is the best doctor in [Any Town, U.S.A.]”. The search results in response to the query typically deliver to the individual a laundry list of websites which contain lists of the so called top doctors. The lists are often accompanied by advertisements, articles about the field in which the doctor practices, solicitations to schedule an appointment, and other information that the content provider believes are relevant. The lists may contain the name of the doctor, their board certification, and information to reach their office. Often, however, the websites do not disclose the methodology for selecting the top doctor and, as a practical matter, a true appraisal of the skill, training, and expertise of the doctor. In reality, when individuals perform their own research to locate the top doctor, the research raises more questions than answers.

Commercial content providers use a variety of means in which to identify and rate professionals in a given field. One of the means is known as peer review. It is known in the art of peer review for commercial providers to perform assessments along both horizontal (similar function) and vertical (different function) relationships to arrive at a list of top professionals. In either a horizontal or vertical relationship, the reviewer is requested to appraise the performance of professionals under review. For example, such reviews are often published in magazines entitled “Top” doctors, lawyers, etc.

Peer review suffers from a number of limitations. Limitations in peer review exist in the pool of reviewers, the quality or acumen of the individuals doing the reviewing (i.e., the reviewer), the characteristics of the professionals under review, the lack of a true control group against which to compare the professionals, and the risks that a reviewer may attempt to express his or her own dislikes with the professional under review in order to advance their own personal agenda. A peer review system can open the door to subjective, as opposed to, objective criteria to assess the performance of the professional under review. Additional limitations in a peer review system include the lack of obtaining a full and complete assessment of all of the professional's background, affiliation, and interaction with non-peers to determine the quality and quantity of the professional's skill, training, and experience.

As yet another limitation in a peer review system, many commercial content providers harvest information through the use of surveys of members of a profession. The surveys often include questionnaires to solicit responses that contain information to enable the reviewer to assess the skill, training, and reputation of the professional under review. Responses are gathered, reviewed, and a list that supposedly contains the “top” rated individuals in a given profession is published. Often times, however, questionnaires fall short in capturing an objectively fair appraisal of the performance of the professional. Increasing the unlikelihood of a fair appraisal of the performance of the professional is the financial motivation underlying many peer review systems.

Commercial content providers, such as publishers of periodicals and magazines, use the top list to generate sales of the publication by populating the content with a greater number of the so called “top” professionals in order to appeal to a broader circulation of readers. The financial motivation of the commercial content providers dilutes the independence and reliability of the list of the top professionals that is published in the magazine.

Attempts to produce a reliable assessment of the skill level of professionals have been pursued. For example, U.S. Pat. No. 8,412,564 (the “'564 patent”) is directed to a system and method of identifying excellence within a profession. The claimed method in the '564 patent is directed to a processing device for identifying excellent performance of candidates within a professional group, based on a candidate pool of individuals selected from a profession group. The candidate pool is selected based on a survey of peer professionals and the results of independent research to identify individuals who satisfy predetermined criteria. Each candidate is assigned a weighted score that is used to narrow the candidates under consideration to further define the candidate pool. The candidates comprising the candidate pool are evaluated and assigned point totals which are used to select a first predetermined top percentage of candidates. The first predetermined percentage of candidates are subject to further peer evaluations and scoring to result in a second predetermined top percentage of candidates that are identified to the user.

Several limitations exist with the method disclosed in the '564 patent. First, there is an absence of criteria used for selecting the candidates. Second, the independent research in the '564 patent is not based on actual evaluations of the candidate's background, but rather is based on a data mining process that performs an electronic inquiry of data sources that relate to biographical information of the candidate under review. The independent research does not take into account non-electronic information about particular professionals which may disclose intangible attributes, opinions, and critical information about the actual performance of a given professional as observed by individuals who may not qualify as peers. The invention disclosed in the '564 patent fails to incorporate an accurate and comprehensive assessment, also known as a full 360 degree review, of the background and performance of the professional which is critical to arriving at a more factual, practical and reliable evaluation of the skill, training, and expertise of the professional under review. Also, the method of the '564 patent does not permit the user to customize the selection criteria and other elements which are objectively and subjectively used as part of the search process. Therefore, the system and method in the '564 patent does not accurately result in an accurate and comprehensive assessment of the actual skill level and experience exhibited by the professional, as observed by peers and non-peers, relative to the specific or specialized services performed by the candidate under review.

For these reasons, there remains a need for a system and method for identifying the top performing individuals working in a given profession based on their background, performance evaluations, and professional assessments. In particular, there remains a need to provide a method by which individuals who are searching to retain a professional have a reliable resource that provides a fair and unbiased assessment of the skills, reputation, training, and background of the professional relative to a specialized field of work. For these reasons, it is an object of the invention to provide a reliable system and method for identifying the top professionals working in a given field. It is a further object of this invention to provide a system and method of identifying the top professionals working in a given profession based on criteria that is modifiable by the user, following an accurate and comprehensive evaluation of information related to the professional under review. The evaluation will yield reliable information that is predictive of future performance by the professional and will result in a more reliable appraisal of the professional's performance.

### SUMMARY OF THE INVENTION

The present invention is directed to a system and method for identifying top performing individuals who offer specialized services within a given professional field based on evaluations of the skill, training, background, and professional assessment of qualifying individuals. The method includes the steps of forming a solicitation board to solicit nominees working within a given field relative to pre-determined criteria. The nominees comprise individuals working in the given field who self-nominate, who are nominated by third party individuals, or who are nominated by peers. The solicitation board reviews all nominations, develops additional background information relative to each nominee and then selects a pre-determined number of nominees to form a first tier of candidates. The solicitation board conducts an assessment of each nominee and narrows the number of nominees comprising the first tier of candidates based on a pre-determined percentage, thereby forming a second tier of candidates. Information directed to each candidate is retrievably stored in a searchable database. The searchable database contains a series of relational files containing background information developed through the solicitation and nomination process that are associated with each candidate under review by the solicitation board. The solicitation board performs a comprehensive, multi-source feedback and assessment, including interviews, as a means to select a pre-determined number of nominees in the second tier to form a third tier of candidates.

A review board reviews information related to pre-selected candidates of the third tier based on a consideration of information and data developed through self-assessments, staff surveys and direct surveys. The review board will conduct an accurate and comprehensive evaluation of the skill level and expertise of the candidates, use a weighted scale to rank the candidates, and then form a third tier of candidate. The review board continues its review process and narrows the field to define a fourth tier of candidates. Out of the fourth tier of candidates, the review board selects a final tier of candidates who are considered to be among the top performing individuals offering services in a given profession.

Preferably, the method described above is implemented using a computer, comprising a processor, database, and programmable software that is designed to enable the analysis and evaluation of the candidates as a supplement to the review performed by the review board.

In an alternative embodiment, the method enables a user to modify search criteria used by the searchable database to identify the top professionals having demonstrated a predetermined level of superiority within a specialty of the given field as determined by experience, reviews by the public and other related criteria.

In another alternative embodiment, the method enables the user to modify search criterial used by the searchable database to identify professionals demonstrating a predetermined level of superiority within a pre-determined locale according to the above criteria evaluation.

### BRIEF DESCRIPTION OF THE DRAWINGS

FIG. 1 is a flow diagram illustrating exemplary different phases of FIGS. 2-5 of the method according to one embodiment of the invention

FIG. 2 is a flow diagram illustrating the steps of the solicitation phase of the present invention.

FIGS. 3A and 3B are flow diagrams illustrating the steps of the selection phase of the present invention.

FIG. 4 is a flow diagram illustrating the steps of the assessment phase of the present invention.

FIGS. 5A and 5B are flow diagrams illustrating the steps of the review board phase of the present invention.

FIG. 6 is an illustration of an exemplary computer for use in implementing the method of the present invention.

FIG. 7 is an illustration of a partial isometric view of an exemplary database storage unit as part of the memory of the computer shown in FIG. 6.

FIGS. 8A, 8B, 8C, and 8D are illustrations of exemplary relational data stored in tables that are associated with the database storage unit illustrated in FIG. 7.

FIG. 9 is an illustration of an exemplary network connected using the world wide web, in which one or more exemplary computers of the type illustrated in FIG. 6 sits behind a firewall.

### DETAILED DESCRIPTION OF THE INVENTION

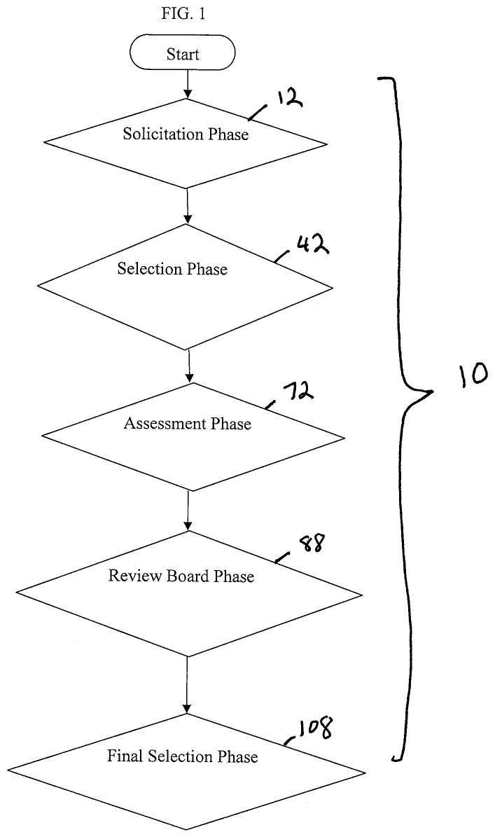

A system and method 10, FIG. 1, according to an embodiment of the present invention for identifying the top professionals working in a given profession is shown in FIGS. 1 to 9. The steps of method 10 are modifiable by one of ordinary skill in the art of the method, by enabling the user to identify one or more top professionals working within a specialty of a given professional field. As used herein, the term “top” includes the type of professional who demonstrates his or her excellence in their field, who is to be objectively considered according to criteria set forth herein by peers and others to be among the leading or foremost experts in their field, who is to be objectively considered by members of the public to be among the top professionals working within the field, and/or is believed to deliver exceptional services in a specialty or subspecialty of the given professional field, based on an evaluation of information discussed herein.

Method 10 consists of five phases 12, 42, 72, 88 and 108 as shown in FIG. 1-5, which enable the user to create a list of one or more professionals performing services within a specialty or subspecialty of a given professional field which can be relied upon by consumers when selecting a professional to perform a particular service. The top professionals working in a field should have preeminent skills, experience, and reputation within the given field in general or within a specialty or sub-specialty in the given field. In other words, the top professional is one who is regarded as having superior attributes that are typically preferred by individuals interested in the services of the same or similar professionals working in a given field. As described herein, the top professional is determined by a comprehensive, 360 degree feedback evaluation of traditional and non-traditional attributes of the professionals' skill, training, experience, background, reputation and standing in the profession. The method enables the consumer to better predict the quality and nature of the services to be delivered by the professionals. Method 10 does not guarantee the services being performed by the professional.

Method 10 is scalable. The scalability provides flexibility to design method 10 to fit the particular characteristics, qualifications, and criteria that is associated with a particular profession. Method 10 is adaptable for use in the construction, real estate, accounting, legal, medical, and engineering fields or any other field of work in which individuals are employed based on his or her training, skills, and performance. For purposes of illustrating the invention, and not by way of limitation, method 10 will be described from time-to-time herein relative to the medical field, particularly plastic surgery.

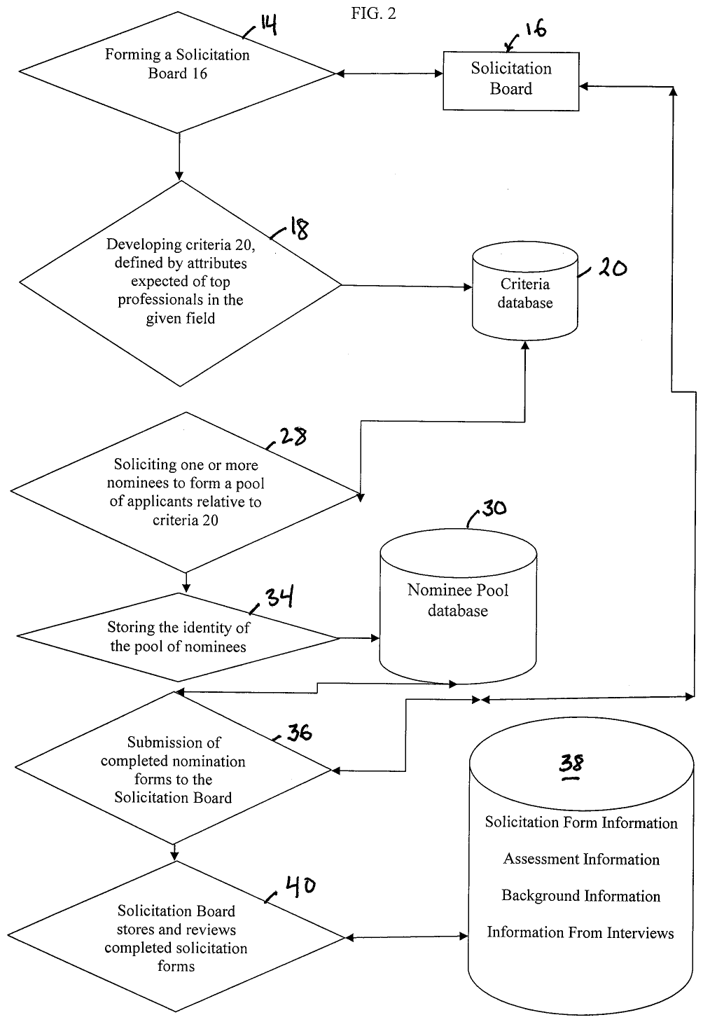

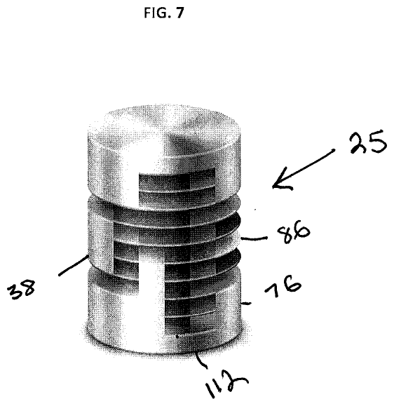

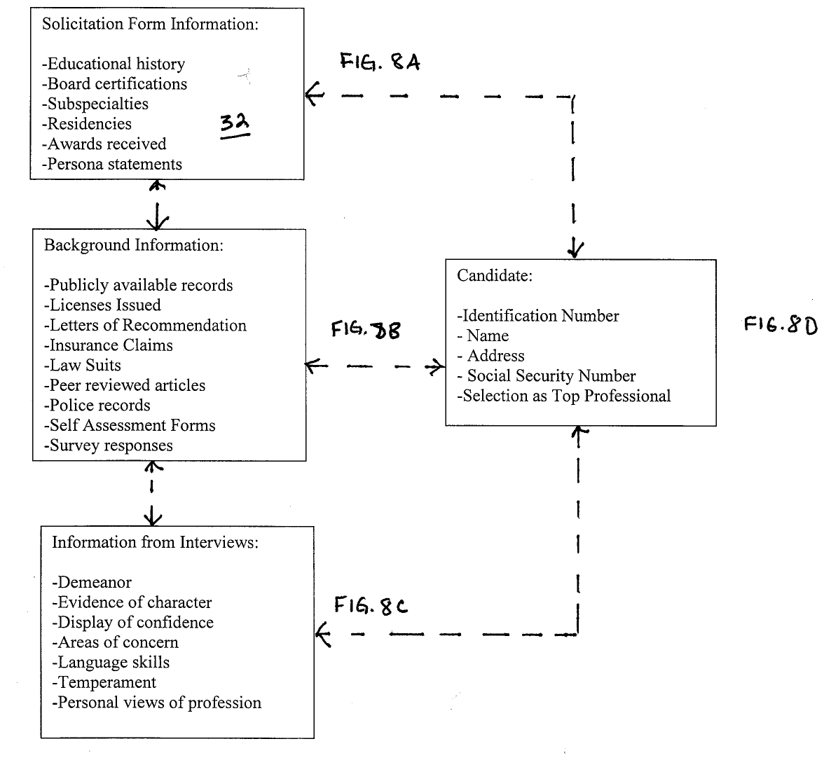

As illustrated in FIGS. 1 to 5, the steps defining method 10 are grouped into a plurality of discrete but related phases. Phase 12 comprises steps for soliciting a group of nominees. At step 14, best seen in FIG. 2, a solicitation board 16 is formed for the purpose of selecting nominees and, at step 18, developing criteria 20. The solicitation board 16 comprises at least one individual member having a desired level of skill, training, and experience for reliably soliciting nominees based on pre-determined objective criteria as defined in part by data of FIGS. 8A, 8B and 8C, for use by the solicitation board 16. Preferably, at least two individual members form the solicitation board 16.

Criteria 20 define attributes possessed by an exemplary hypothetical professional who is among the top professionals working in a given field in a given specialty or subspecialty. The attributes of criteria 20 relate to: the type of profession; the population of licensed individuals working in the profession; the percent concentration of similar professionals in a given locale; the education, training, and active years of practice; professional licenses held; trade association memberships; professional board memberships; the years of practical experience, professional awards received; the educational background; and any of type of information or data that would be typically relied upon by an individual seeking to retain a professional to select one professional from another professional as illustrated in FIGS. 8A, 8B, and 8C.

Criteria 20 are objective characteristics to narrow the field of professionals to be nominated by defining the minimum standard of skill, training, and experience expected to be possessed by hypothetical top professionals working in the given field. The solicitation board 16 develops the characteristics defining criteria 20 based on a consideration of the type of field from which the top or foremost professionals will be identified, based primarily on the professionals' education, training, skill, experience, and reputation. For example, in the field of plastic surgery, the solicitation board 16 considers the desired level of skill, training, education, and experience expected to be possessed by a hypothetical plastic surgeon. The hypothetical plastic surgeon should receive his or her medical education from an approved medical school, be board certified in plastic surgery and associated subspecialties, hold membership in the American Society of Plastic Surgeons, have a number of years performing plastic surgeries, and have a number of years of experience handling post-operative complications. The hypothetical plastic surgeon should possess other attributes that are deemed to be pertinent, such as the number of claims filed against the surgeon, the number of complaints raised by patients, and the opinions of medical support staff who have had an opportunity to personally observe the work of the hypothetical surgeon.

The attributes of criteria 20 position the solicitation board 16 to make a reasonably fair and objective appraisal of nominees to be considered to fall within the class of the top professionals in the field based on a comprehensive, multi-source feedback and assessment (also known as a 360-degree feedback and assessment) of all information collected about the nominee. Criteria 20 can be modified to alter the attributes desired of the hypothetical professional. In an alternative, the solicitation board 16 may desire to publicly publish criteria 20 in trade journals or using the Internet, so that potential nominees can understand the attributes of the hypothetical top professionals.

It should be understood that criteria 20 is used as part of method 10 to identify the top professionals not only working in a given field, but also providing services in a specialty or sub-specialty. Criteria 20 comprises an array or plurality of discrete factors that fine the type of attributes of a preferable candidate who should be considered as a top professional. For example, by way of illustrating the nature of attributes to be used as criteria 20 with the present invention, the field of plastic surgery is divided into two general categories: reconstructive and cosmetic surgery. Reconstructive plastic surgery is performed to correct functional impairments caused by burns; traumatic injuries, such as facial bone fractures and breaks; congenital abnormalities; developmental abnormalities; infection and disease; and cancer or tumors. Cosmetic surgery is an optional procedure that is performed on normal parts of the body with the purpose of improving a person's appearance and/or removing signs of aging. Subspecialties of plastic surgery include: aesthetic surgery, burn surgery, craniofacial surgery, oral and maxillofacial surgery, hand surgery, microsurgery, and pediatric surgery as a handful of examples. Because the proficiency of a given surgeon specializing in a particular specialty may possess techniques that may be the same or different than other subspecialties, criteria 20 should be designed to identify as one or a plurality of discrete attributes specific skills, knowledge and training expected of surgeon practicing. In that way the hypothetical top plastic surgeon creates a standard against which nominees will be measured to determine if said nominee possess the same, lesser, or superior skills in the specialty. Criteria 20 is advantageously used to identify the surgeon performing face lifts, nose surgery, breast implants, lip enhancement, tumor removal, laceration repair, scar repair, hand surgery, and the like who is at the pinnacle of his or her chosen specialty or subspecialty. Criteria 20 is stored in a database that is part of the memory of a computer.

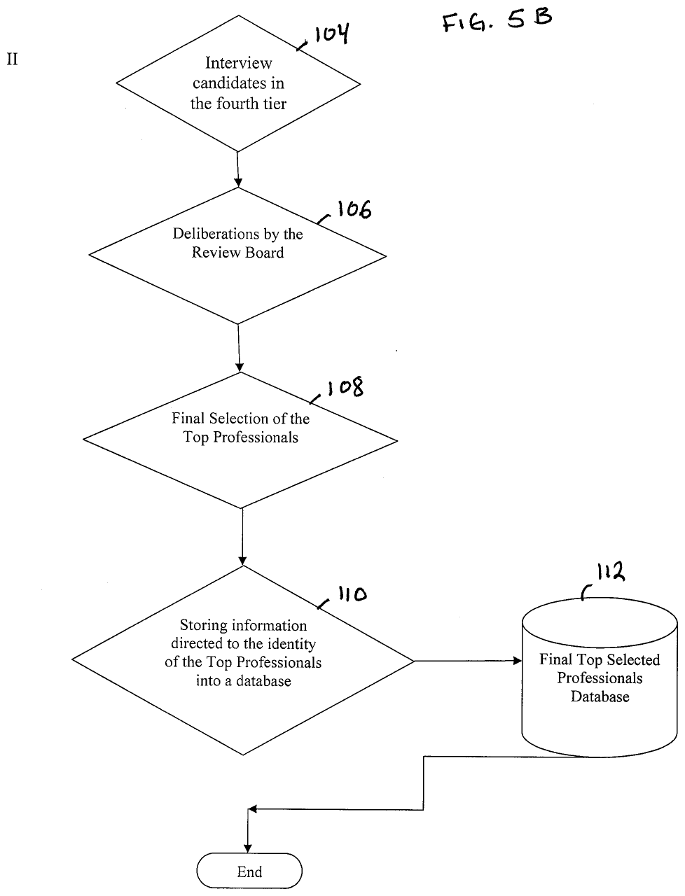

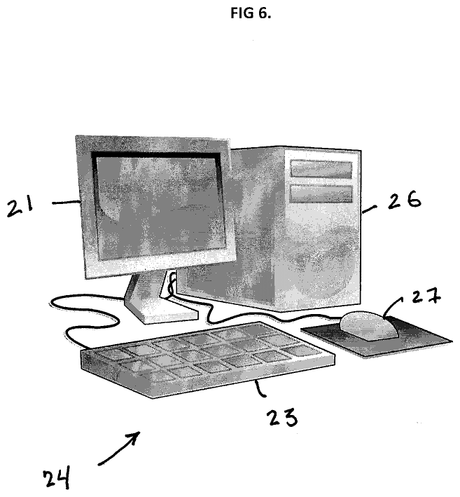

As illustrated in FIG. 6, a specially configured computer 24 supplements the work of the solicitation board 16, particularly with the task of creating or modifying criteria 20 and performing the comprehensive, multi-source feedback and assessment. Computer 24 begins as a general purpose computing device well known in the art. Computer 24 includes, but is not limited to, a server 26 housing memory (see FIG. 7), a processing element (not shown), such as a central processing unit, a keyboard 23, an optional mouse 27, and a display 21 in communication with each other to facilitate the entry of information and data of the exemplary professional. Memory 25 is used with the processor element as a means to retrievably store information and data in a database, such as criteria 20. Preferably, memory is used to store a relational database system, such as MySQL, and application software that is designed to operate computer 24. The application software will include algorithms and other mathematical calculations written in computer language, such as PhP and C++, that is accessed by the processor element to perform functions, steps, and assessments as part of the operation of method 10.

Computer 24 enables the solicitation board 16 to use application software designed for the purposes of creating and modifying criteria 20 to identify specific qualities that potential nominees should possess. For instance, the software running on computer 24 can be used to identify a list of the desired attributes, based on the particular field or subspecialty under consideration, the locale of the professionals considered for nomination, and nature of the profession. It is contemplated that a member of the solicitation board 16 can customize criteria 20 to arrive at the types of attributes that the foremost professional should possess. An algorithm or source code to perform the functions and steps herein are written using known computer languages, such as C++, C, PhP, and the like as several examples.

Returning to FIG. 2, at step 28, the solicitation board 16 solicits one or more nominees to form a pool of applicants 30 relative to criteria 20. The applicant pool 30 is defined by one or more nominees from at least one of the following three sources: self-nominations, individual nominations, and peer nominations. A self-nomination occurs when an individual working in the field nominates himself or herself as possessing attributes that meet or exceed criteria 20. Self-nominations are subjective evaluations that an individual undertakes when considering whether they should submit a nomination. To self-nominate, an individual fills out form 32 (FIG. 8A), preferably in electronic form, and submit the completed version of the form to a designated individual or location identified by the solicitation board 16.

Form 32 provides a responsive written means for collecting background and biographical information regarding the nominee. The form 32 contains questions and categories of inquiry to solicit information to expose whether or not a nominee has attributes that meet or exceed criteria 20. Form 32 invites the person completing the form to identify: the name, address, and telephone number of the nominee; the education background, including degrees held and the educational institution(s) attended; the training received in a given field; awards received; personal statements; description of experience; a descriptions of the types of services provided to individuals (i.e., patients, clients, customers, and the like); and references. In the context of the exemplary hypothetical plastic surgeon, form 32 invites the individual completing the form to supply information such as: high school(s) attended, college(s) attended, college degrees awarded, medical school(s) attended; the nature and extent of any residency, hospital privileges granted or denied, board certification(s), subspecialties, the nature and amount of plastic surgeries performed, complications experienced during or post-surgery, the years of experience, and any attributes that the nominee deems relevant, as solicited through the form 32. Completed versions of form 32 are submitted to the solicitation board 16 and electronically stored in database 38 of memory 25 using known techniques.

Form 32 can also be completed by both individual nominees and peer nominees. Individual nominees are those individuals who nominate someone else by completing form 32 and submitting the completed version of form to the solicitation board 16. Peer nominees are individuals who are peers of a particular professional and elect to submit a nomination based on his or her belief that the particular professional possesses attributes that meet or exceed criteria 20. Peer nominees complete form 32 and submit the completed version of the form to the solicitation board 16. All completed forms are submitted to the solicitation board 16, at step 36 and at step 40 is stored in a database 38 that is part of the memory 25 of the computer 24.

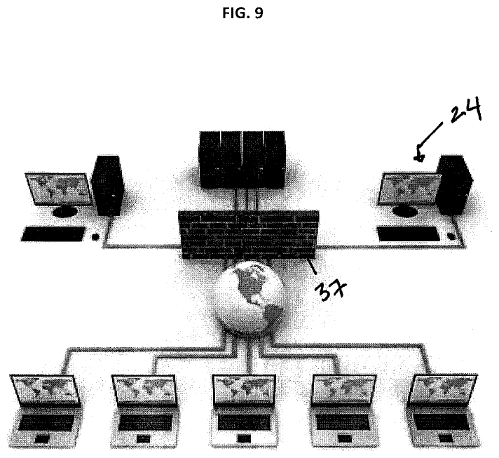

Database 38 is a single or enterprise level warehouse in which all of the information developed about the nominees is be stored as part of a relational database management system, such as open source MSQL, accessible via the Internet or web applications, and is accessible via computer. The database 38 (illustrated in FIG. 7) is multi-level and is deployed in an enterprise level architecture in which one or more electronic devices can access it. For example, as Illustrated in FIG. 9, database can be located within one or multiple servers, to which external computers have access via the Internet. Access to the servers housing the database are in communication with electronic devices, such as lap top computers, personal handheld devices, applications, computers, cellphones, tablets, and other means of accessing the servers. Each device is designed for logical access to the database 38, which preferably sits behind a firewall 37. The use of more than one server is desired in order to increase the scalability of the method to efficiently and quickly provide access to the information stored in the database 38, particularly when multiple applications are seeking to access the same information simultaneously.

The solicitation board 16 reviews all completed forms at step 40. Completed forms are akin to applications for a position. The solicitation board 16 reviews completed forms for accuracy and performs an assessment relative to criteria 20. If a nominee's completed form does not establish that the nominee possesses attributes that meet or exceed criteria 20, the nominee is eliminated from consideration. Whether or not a nominee possesses attributes that meet or exceed criteria 20 is an objective review that lies in the sole discretion of the members of the solicitation board 16.

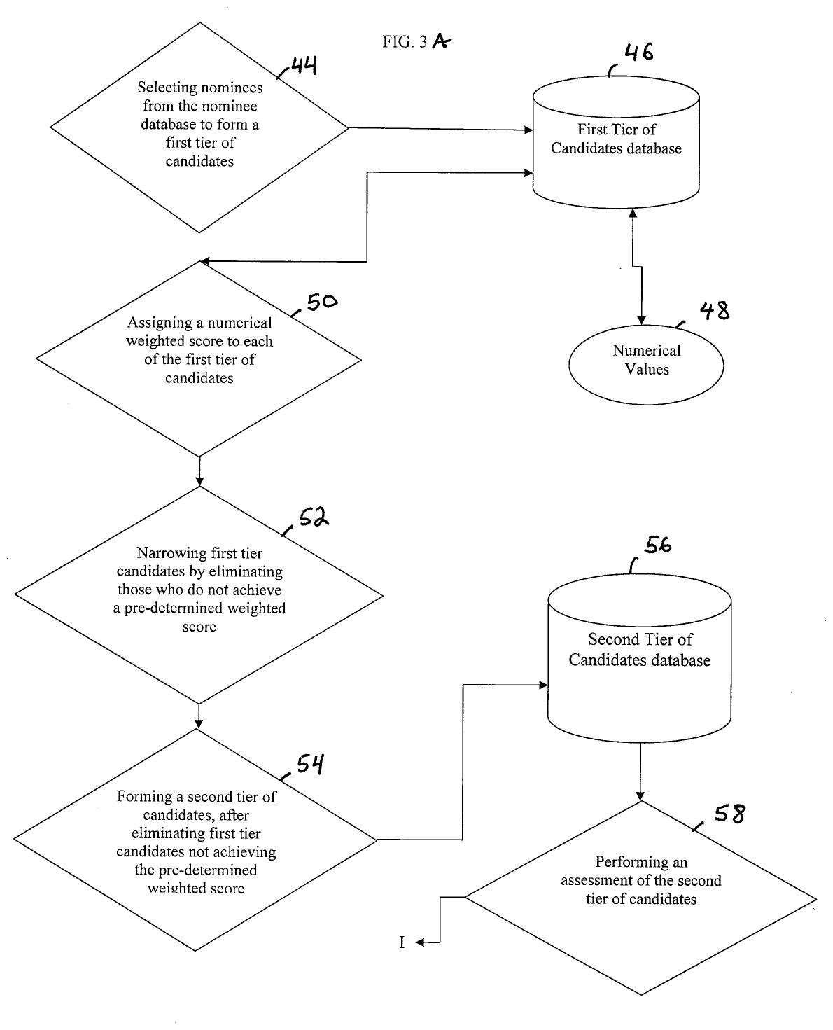

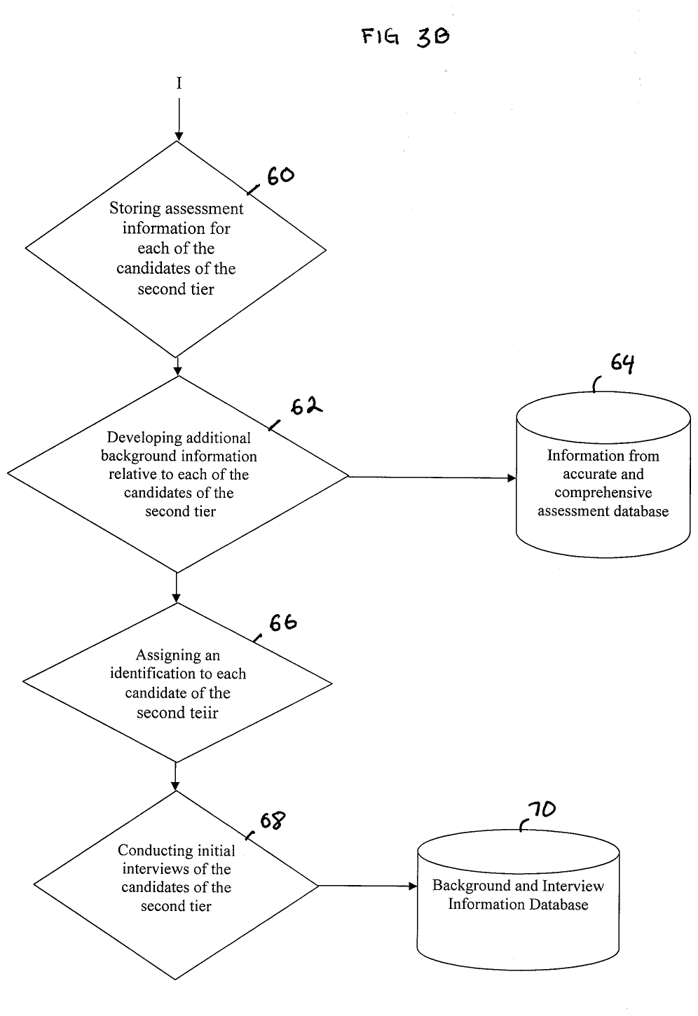

After the solicitation phase 12, the selection phase 42 begins. A shown in FIG. 3, at step 44, successful nominees are selected by the solicitation board 16 to form a first tier of candidates, the names and background information of which are retrievably stored in a database 46 that is within memory 25. Preferably, members of the solicitation board 16 use a score card (not shown) to assign a weighed numerical value to each of the elements of criteria 20, as an indication of the degree to which the nominee's background and attributes meet or exceed the given criteria. The numerical value (such as points or scores) are stored in a database 48 and can range from the lowest to the highest, such as the value “1” to “20”, with 1 being the lowest value and 20 being the highest value. A “1” indicates that the nominee has attributes, training, and experience at its most basic level consistent with the given element of criteria 20 and a “20” indicates that the nominee has attributes, training, and experience that exceeds the most basic level. It should be understood that any weighed scale to rank or rate the attributes of the nominees during the selection process can be used.

The total numerical values achieved by each nominee are calculated and the sum of all numerical values for all criteria 20 is also calculated. For example, if there are 20 separate categories that define criteria 20 and the maximum numerical value obtainable for each category is 20, then the total score for the combined categories is 20×20, or 400. 400 is the highest total score that a nominee can achieve if the nominee receives the highest point total for each category. Therefore, at step 50, for each nominee, the selection board 16 assigns a numerical value for each category of information reviewed that is associated with each nominee, and then assign a percentage of the total value achieved. For example, if a nominee receives a total numerical value of 7 on each of the 20 categories, the total score for the nominee is 140 (i.e., 7×20). To rank each nominee, the percent scale relative to the total number is calculated. In the example discussed, the numerical value sum total of 140 divided by 400, is the 35^{th} percentile or 35%. Similar calculations are performed for each of the nominees to determine their percentile.

It should be understood that any statistical means can be used to rank or rate each of the nominees. The purpose of using the statistical means is to apply a manner in which to rank one nominee relative to each other, which facilitates the ultimate selection of nominees for purposes of continuing the review process. The score card can be based on any total number of values, points, weighted score, or numbers assigned by the selection board 16 which aids the ranking the nominees. In the preferred embodiment, the selection board 16 targets a pre-determined, minimum percentile that each nominee should receive to be selected for further review or passed along as part of the first tier of candidates. All nominees having point totals that that equal to or exceed the predetermined minimum are selected. Each selected nominee 44 becomes a formal candidate for consideration to include among the foremost professionals.

At step 52, the solicitation board 16 narrows the number of nominees comprising the first tier of candidates by eliminating nominees who achieve a percentile that is at or below a pre-determined percentage. The pre-determined percentage is a number that is selected by the solicitation board 16 for which nominees must meet or exceed. The pre-determined percentage can be 80%, 50%, 30%, or any other number or percentage desired. The purpose of selecting the percentage is to enable the solicitation board 16 to narrow the pool of nominees from which the foremost professionals may be selected. As an alternative embodiment, the solicitation board 16 uses a fixed number of nominees to select, such as 10, 20 or any percentage that is less than the total number of nominees that form the first tier or candidates. At step 54, the selection board 16 narrows the field of candidates from the first tier of candidates to form a second tier of candidates based on the percentage or fixed number. The solicitation board 16 selects any desired number to form the second tier of candidates. The names and background information associated with the candidates forming the second tier of candidates is retrievably stored in database 56.

At step 58, the solicitation board 16 performs a comprehensive, multi-source feedback and assessment (i.e., a 360-degree feedback and assessment) of all information collected about the nominee of the candidates of the second tier. The comprehensive assessment will increase the quantity and quality of available information and data about each candidate of the second tier. Increasing the quantity and quality of available information is advantageously used as part of method 10 to arrive at a list of the top professionals in the field. It is contemplated that increasing the information about a candidate is proportional to an increase in the reliability of the 360 degree assessment of each candidate.

As part of the assessment, the solicitation board 16 develops additional background information on each of the candidates. The background information is harvested or mined from information that is publicly available, privately available, and accessible from independent research performed either manually or electronically. For example, information may exist in the form of public searchable records, educational records, licenses issued, previous applications submitted to a licensing board, letters of recommendation, insurance claims, lawsuits, court proceedings, trade journals, personal surveys, police records, articles, peer reviewed articles, and similar forms of information about the candidate that is available from word of mouth, the Internet, or other means. Preferably, the solicitation board 16 hires one or more investigators to develop background material that many not have been submitted during the nomination process. The purpose of developing the background information to identify details about each of the candidates of the second tier beyond information typically obtained through the information provided as part of the solicitation process. All information and material that is gathered as part of the comprehensive assessment is sorted at step 62 in a database 64 relative to each candidate at step 66.

As shown in FIG. 3B, after the additional background information and material are developed, the solicitation board 16 conducts initial interviews of the candidates of the second tier at step 62. The interview is part of the comprehensive assessment of the skill, training, and attributes of each candidate. The solicitation board 16 assesses the candidate's demeanor, evidence of character, display of confidence in delivering services, areas of concern, language skills, temperament, and professional views of the profession. The assessment is made through a question and answer session or an information exchange session. The information received as part of or following the interview of the candidates is added as part of the background information of each candidate.

Each candidate will be assigned an alphanumeric identification (I.D.), or some other form of identification to distinguish each candidate from the other, at step 66. All information related to a particular candidate will be reduced into an electronic form and stored in a searchable and/or a retrievable format in database 38. The information is encrypted in order to maintain privacy and to satisfy HIPPA privacy requirements. Any typical encryption paired key software can be used to encrypt the information. Access to database 38 will be controlled by known logical access systems in which the individual or application seeking access will be required to present credentials that must be authenticated and verified before access is granted. The candidate's I.D. will be associated with all information developed that refers to the candidate. All information is stored at step 68, in a database 70 that operates within database 38.

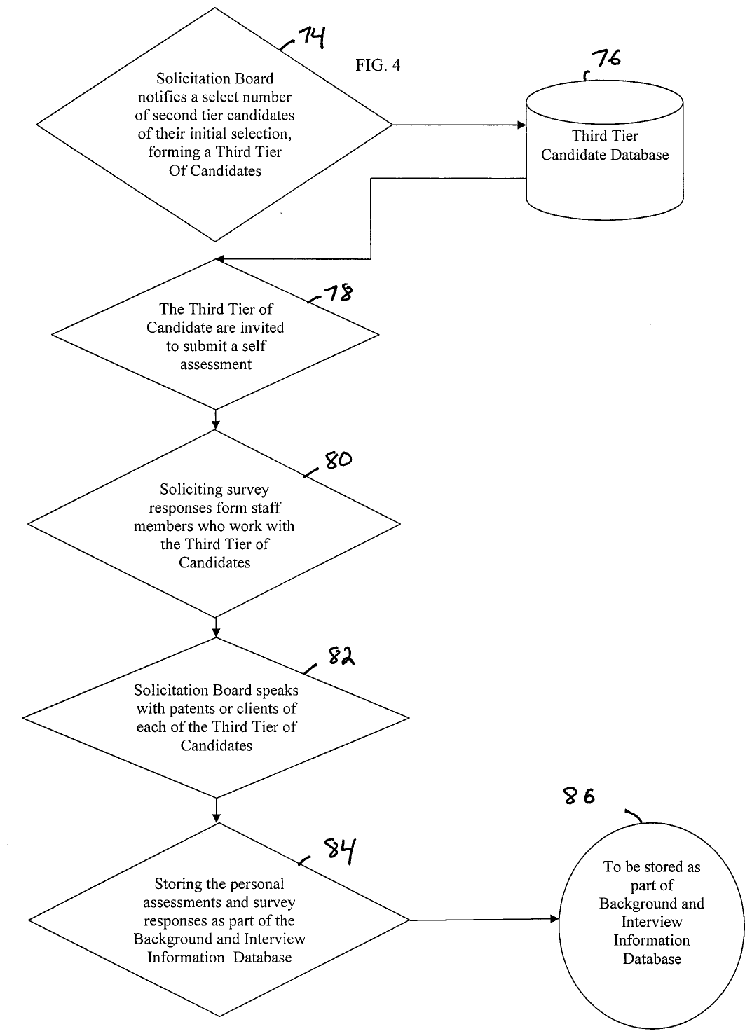

The assessment phase 72 commences. As shown in FIG. 4, the solicitation board 16 notifies a select number of the second tier of candidates of their initial selection, at step 74. Notice of the selection is in any typical form, such as through a letter, email, or other communication means which advises the candidates that they were successful in the solicitation process. The selected candidates thereby defined a third tier of candidates and their name and information are stored in a third tier candidate database 76 that is within memory 25.

After the notification has been communicated to the selected candidates of the third tier, each third tier candidate is invited to submit a self-assessment with regard to their professional acumen, performance in the given profession, and overall opinion regarding their level of skill, at step 78. In a preferred embodiment, candidates perform a self-assessment of their procedures used, the results achieved, and attributes of the manner in which they provide services which they consider to be unique. The goal of the self-assessment is to provide the candidate with an opportunity to share their subjective beliefs as to why they should be considered as falling within the group of the foremost professionals in their given field and to provide any other information that they would like the solicitation board 16 to consider. For example, a plastic surgeon is invited to report data and statistics with regard to: the number of surgeries, the complexity of the surgeries, the results achieved, the types of patients treated, any complications experienced during surgery, any post-operative complications, the satisfaction of the patients, and any articles written regarding the surgical procedures used. Because self-assessments generally test the limits of honesty and integrity, each candidate is requested to attest to the truth and accuracy of the information provide in the self-assessment. The self-assessment is submitted in the form of a written submission or responses to additional questions created by the solicitation board 16. Preferably, a self-assessment form will be sent to each of the third tier of candidates that will be completed and returned to the solicitation board 16.

For medical practitioners, a pre-determined percentage of all of the self-assessments received are audited and records requested in a Health Insurance Portability and Accountability Act of 1996 (“HIPPA”) compliance process. This compliance process is used by several known medical Boards, such as the Board of Plastic and Reconstructive Surgery, during the maintenance of certification evaluation.

As part of the self-assessment submission, medical practitioners are asked to review a pre-determined number of procedures performed within a given period. The predetermined number is a value expressed in numerical terms that is determined by the solicitation board 16 to provide a statistically sound population of procedures to yield reliable conclusions. The statistical population or a statistical model should have sufficient information so that statistical methodologies known in the art can be used to determine the skill level of the candidate submitting the self-assessment, as being predictive of the candidate's likely performance in the future. As an alternative embodiment, the procedures are measured against standards that represent the minimum skill level desired to be possessed by the candidate. In a preferred embodiment, at least 10 consecutive procedures performed within the previous two (2) years are desired. These procedures must match a version of the particular procedure or procedures for which a candidate was nominated and selected. In the context of the medical field, the type of procedures to be reported for statistical purposes include, but are not limited to, unplanned take back to the operating room in the 30 day post-operative period, anesthetic complications, need for revision surgery or treatments, complications including numbness, scarring, asymmetry etc., need for blood transfusion by the patient, post-operative infections, operative time, blood loss, below average clinical result, and any other complications and post-operative issues faced by the candidate. Although the reporting of pre-determined procedures at step 86 was described for medical practitioners, it should be understood that a similar model can be used for any candidate from any known profession as part of undertaking predictive analytics of the conduct and performance of the candidate. As an additional example, real estate agents can be requested to describe the procedures used for commercial or residential sales over the course of 10 years. Likewise, attorneys may be requested to review the procedures used to handle a given case over the course of 5 years or 15 years. The purpose is to developed additional information that adds to the comprehensive 360 degree analysis and the evaluation of the skill, training, expertise, and qualifications of the candidate working in a given profession.

In order to provide a basis in which to measure the veracity of the information provided by each candidate at the self-assessment, the solicitation board 16 solicits surveys from staff members who know or work with the candidate, at step 80. The purpose of the survey is to develop objective data and information in which to measure the accuracy and reliability of the information provided by the candidate as part of the self-assessments. In a typical work environment, professionals work with staff members who include, but are not limited to, non-professionals who have the opportunity to access and personally observe the skill level, work ethic, and expertise of the candidate. The staff member may be full or part-time employees, per diem workers, or volunteers who are positioned to develop first-hand knowledge of the work being performed by the candidate. Based on personal observations, the staff member is positioned to submit a response to the survey based on his or her experience observing and working with the candidate relative to the candidate's work acumen, skills, knowledge of subject matter, relationship with clients, attention to detail, or work habits, either good or bad. Preferably, a plurality of staff members are identified, each being in a similar position and having attributes similar to the staff member previously mentioned. A plurality of staff members is preferably desired because a greater group of individual staff members, who can express views about the work habit of the candidate, provides a greater sample or grouping of information from which the veracity of the completed self-assessments response is measured. Determining the veracity of the completed self-assessments is an important step to determining the reliability of the information and data that the candidates provide to the solicitation board 16.

In a preferred embodiment, the solicitation board 16 uses one or a plurality of surveys, such as an online survey, a paper survey, or a survey that is conducted orally. The surveys comprise a series of questions that are designed to elicit a response from the staff members receiving the survey factual details, opinions, observations, and critiques of the work performance of the candidates being evaluated. The series of questions are crafted to identify specific areas of concern or concentration that identify within a pre-determined level of accuracy material information that is substantively directed to providing a comprehensive, multidimensional informational evaluation of the candidate. The multidimensional informational evaluation includes, but is not limited to, objective and subjective observations with regard to attributes about the candidate that form a basis for measuring the reliability of the information taken from the completed self-assessment and the skill level of the candidate.

The solicitation board 16 targets senior level professionals who know of or who are associated with the candidate for purposes of soliciting surveys. The senior level professionals have first-hand knowledge of the professional's skills, principles, consistency, and overall attitude towards his or her clients or patients. For example, in the medical field, senior level professionals would include: operating room nurse manager, operating room nurses working with the doctor for more than a predetermined number of years, members of the anesthesia department, nurses on the hospital floor, and medical professionals who have had an opportunity to observe the candidates' work ethic and skills during a surgical procedure.

At step 82, the candidates of the third tier are requested to provide authorizations for the solicitation board 16 to speak with and solicit a survey from a predetermined number of individuals who received services from the candidates. The individuals may be patients or clients who underwent a particular procedure for which the candidate is being considered. In the context of the hypothetical plastic surgeon, HIPPA compliant authorizations will be obtained from the patients. The solicitation board speaks with the patients or clients of each of the third tier of candidates to gain further information as part of the comprehensive assessment.

Patient surveys will include questions such as: Are you happy with the results of your surgery? Are you happy with the overall care you received throughout the process? Is there anything related to the procedure and/or experience you are unhappy with? Would you recommend this surgeon to friends and family? Similar types of questions are asked in the survey as part of the comprehensive assessment of the candidate. It should be understood of course that surveys can be used in any profession to solicit information from individuals who have used the services of the professional in the past. Soliciting this type of information adds to the quantity and quality of the information that will be used to assess the skill, training, and experience of the candidate.

The information obtained from surveys and the completed self-assessment for a given candidate is stored in a database 86, at step 84. To maintain privacy, the information is stored in an encrypted format and organized into a manner that increases the ease and frequency of soliciting, storing, and retrieving data. There are many known computer software programs for encrypting information to be stored on database 86. All data in the databases are in a searchable format to facilitate search and response using a Boolean, natural language, and advance term and connector search with known terms. The search function will assist in the reviewing of the candidate files to narrow the field of potential candidates.

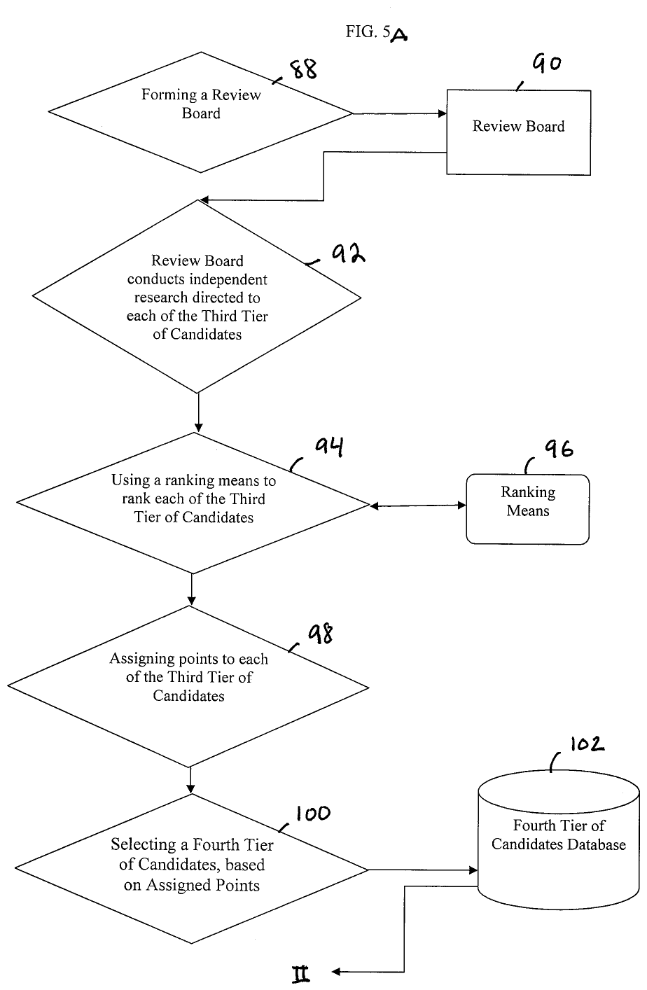

At step 88, the review board phase, a review board 90 is formed as shown in FIG. 5A. The review board 90 includes one or more experienced professionals to review the candidates of the third tier. An experienced professional is an individual who serves on the solicitation board 16 or who has the level of skill, training, expertise, background, and attributes of respect and knowledge in a given field. The experienced professional is selected with the view of giving credibility and reliability to the selection of the candidates. Although one experienced professional can be used, it is preferable that at least 3 or more experienced professionals are selected to form part of the review board 90. It is contemplated that professionals of varying degree, as well as members of the public, are selected to form the remaining parts of the review board. The reliability, reputation, and credibility of the members of the review board is an important characteristic of the process because members of the public and potential clients should have a high degree of confidence in the identification of the leading or top professionals.

At step 92, the review board 90 conducts independent research of each of the candidates of the third tier. The independent research includes a review of: the background data collected during the solicitation and nomination process, publications by or on behalf of the candidates, review of the self-assessments, review of the surveys, review of publically available information on the Internet, research to find other information about the candidate (including criminal background checks), and a search for and review of any information source that will further develop a full and comprehensive valuation of the candidate beyond peer reviews. The comprehensive valuation will provide details about the qualities and experience of the candidates that may not be otherwise disclosed. A critical part of the comprehensive valuation will be the combination of one or more sources of information that are reviewed so that a reliable assessment is made of the skills and expertise of the candidates. For example, in the plastic surgery context, observations from an attending nurse regarding how well or poorly the physician performs plastic surgery is particularly valuable. The nurse can express whether the physician (i.e., the candidate) follows generally accepted procedures, deviates from the acceptable procedures to place the patient at unreasonable risk for injury or complications, uses quality of stitches, reduces the risk of noticeable post-operative scars on the patient, and the like. The review board 90 also contacts existing or former patients or clients of the candidate, to solicit an assessment of experience with the candidate. The review board 90 conducts interviews, reviews articles, contacts the candidate's references, investigates the candidate's reputation, and reviews any source of information that is privately or publicly available.

At step 94, the review board 90 uses a weighted ranking means 96 to rank the candidates of the third tier, following the independent research and a review of all other material gathered, namely: the completed nomination forms; self-assessment, individual assessments; peer review; background information; procedures performed; and surveys. All of the information gathered and reviewed is part of the comprehensive, multi-source feedback and assessment, performed by the review board 90 to make a multiple perspective analysis and appraisal of the skill, training, and expertise of each of the candidates. The comprehensive review will enable the review board 90 to differentiate the skills of one candidate from another candidate.

The ranking means 96 is based on a competition ranking system in which points or values (numerical or other measurable, comparable or standard determining means) are assigned relative to standard criteria used to measure the attributes that should be hypothetically possessed by a leading professional. For example, a preferable ranking means 96 defines a relationship between a set of attributes such that the total accumulated points assigned is ranked higher than the next lower number of accumulated point totals. If an ordinal measurement is used as part of the ranking means, a standard competition, modified competition, or other means is used to break ties that exist with the accumulated point totals. Use of standard competition and modified competition ranking processes are known and incorporated herein. In the context of the medical field, as one example, points may be assigned based on the number of surgeries performed, the number of patients treated, the number of positive peer reviews, the years of overall experience, the types of medical societies or fellowships in which the medical practitioner is associated, and the like. The values should be objectively assigned to define standards of measure that are used to differentiate one candidate from the other. It should be understood that any differential means in which to differentiate candidates from each other can be reliably used to rank the candidates. The differential means is selected to compare the standard attributes possessed by the hypothetical leading professional with the attributes of the candidates. Based on the similarities or differences in the attributes, the candidates are equal to or distinguishable when compared to one another, relative to the hypothetical standard.

At step 98, the review board 90 assigns points to each of the candidates of the third tier. Based on the total accumulated points that can be assigned to a given candidate, the review board 90 selects a fourth tier candidates, step 100, based on a pre-determined number of desired candidates. The names and background information of the fourth tier of candidates is maintained in a database 102. The total number of candidates in the fourth tier is less than the total number of candidates that comprise the third tier of candidates.

At step 104, the review board 90 conducts interviews of each of the candidates of the fourth tier. Interviews of the candidates are face-to-face, either in person or by virtual means. After the review board 90 conducts the interviews, the review board 108 begins the deliberation process 106 to further reduce the number of candidates to a final tier of candidates. The total number of candidates who comprise the final tier is less than the total number candidates in the fourth tier.

At step 108, the review board 90 selects the top or professionals that working in a given professional field, who are at the pinnacle of their specialty or subspecialty. It is understood that the top professional includes the class of professionals that is preferred by individual members of the public relative to the reasons for which they are required to use the services of a professional. The review board 90 will store the names and background information of each the final top selected candidates, at step 110. The names and background information is stored in a separate database 112.

The combination of the steps as shown in FIGS. 1 to 8, create a dynamic, scalable and unique 360 degree review and evaluation of the professionals and their respective background and skills. The 360 degree review and evaluation will turn on a number of specific, professional or practice specific criteria. For example, in the area of plastic surgery, implementation of the method 10 described in this application, as implemented using a combination of a processing device and “hands on” evaluation, will include consideration of the following non-exhaustive list of exemplary categories related to either the nominee or the candidate: (1) Fellowships and special training, (2) review of board the certification, (3) review of state licensure board application and disciplinary actions, if any, (4) American Society of Plastic Surgery Status, (5) years in practice, (6) professional negligence actions or lawsuits, (7) number of procedures performed, (8) academic positions held, (9) procedure specific positions held, (10) history of other awards, evaluations, critiques and opinions by peers, patients and staff, (11) articles, chapters, books written related to a procedure written by the nominee or candidate, (12) lectures given related to a procedure, (13) online patient reviews, (14) review of before and after photos for each procedure performed on a given patient, (15) complications experienced the during any procedures, (16) a review of social medial content belonging to the nominee or candidate, and (17) any other content that is available to be reviewed. These factors, which can be modified for any given profession will provide a more thorough evaluation of professionals to identify the leading candidates in a given field of work. Method 10 extends beyond peer evaluations because the evaluation relies on information that is both subjective and objective, as well as consideration of the performance of the professionals during a particular procedure.

Preferably, the top professionals are selected relative to a series of interchangeable categories determined by the review board 90. Categories can be based upon disciplines or specialties within the given profession of the type that members of the public would be interested in retaining. For example, in the accounting field, the top professionals specialize in disciplines such as, the valuation of small or publically traded business entities, valuation of particular types of machinery, or tax advice with regard to carry over of certain business expenses. In the medical field, the top professionals may specialize in plastic surgery, such as performing aesthetic surgery, burn surgery, craniofacial surgery, oral and maxillofacial surgery, hand surgery, microsurgery, and pediatric surgery as a handful of examples. The specializations can be separate discrete categories for which the review board can select the top professionals. At its discretion, the identity of the top professionals will be published in a trade journal, books or periodicals, and on web applications running on the servers to enable a member of the public to select one or more leading professionals within one of the categories.

The selection of the top professionals will be assigned to his or her data that was stored in the database as a candidate so that the files that belong from the foremost professionals will be easily identifiable. A final database 112 is created which comprises the identity and information associated with the top professionals. The final database is in a searchable format so that a user of a computer system can search the database based on certain criteria or any customized or modifiable terms. Preferably, the members of the public, such as medical patients as one example, can use known software for searching database to enable the member of the public to select a particular professional and modify criteria 20 to reach a different list of the top professionals. Search filters and parameters are based on a set of modifiable parameters that will filter down and narrow the selection of the identity of the leading professional that is desired by the member of the public. For example, the modifiable parameters are based on procedure, gender, age, ethnicity, languages spoken, years in practice, locations, religion, hospital affiliation, where he or she performs the surgeries (office, surgery center or hospital), number of cases performed annually (specific to procedure), academic titles or leadership positions, medical school attended, and residency program attended. Being able to modify the parameters will help the user narrow the potential field of professionals from which to choose.

It is contemplated that the system and method 10 described above is adaptable to a variety of vocations or professional fields, including the medical field, the legal field, the accounting field, the teaching field, the field of pharmacy, the field of mental health, and any other field in which an individual is required to obtain a license to offer services to the public. It is further contemplated that the system and method 10 identifies the top “5”, “10”, “20”, or any other predetermined number of licensed professionals who work in a given profession who are selected to be in the final tier. The system and method 10 is scalable so that it can be used for an occupation for which a person is trained or qualified to perform a task. It is contemplated that the system and method 10 is dynamic such that certain steps of the method can be modified in a manner to serve the person who is seeking to retain a licensed professional, modified in a manner to arrive at an identification of the final candidates based on criteria that is identified by an individual as being relevant to a search of the database within a particular professional field or within a particular specialty in the given field, to arrive at a desired result.

It is also contemplated that the present invention can be used in conjunction with statistical techniques to predictively model the type the professional services a given professional will provide in the future. In particular, based on the comprehensive assessment of present and historical facts regarding the work of one the given professionals, certain patterns, data, and other forms of information are developed. The patterns, data, and information developed relative to the professional disclose behavioral trends or techniques that are indicative of the likely conduct of the professional. Those of ordinary skill would appreciate that predictive analytics (or modeling) encompasses a variety of techniques that concern many factors to enable the user to make predictions about the decision making, by extracting information from data and behavioral trends associated with the professional. The objective of using a predictive model is to assess the likelihood that a similar occurrence will happen in the future or to reduce the risk of certain events. It is known in the art of predictive analytics, regression and linear regression models are used. A regression technique focuses on establishing a mathematic equation as a model to represent interaction between different variables. A linear regression analyzes the relationship between the response and a set of independent or predictor variables. Both a regression and linear regression technique can be advantageously used as a means in which to use the data from the databases 38, 76, 86, and 112 to predict performance of the candidates selected by the final review board. It is contemplated that discrete choice models, logistic regression, multinational logistic regression, multivariable adaptive regression, and machine techniques work with the method 10 of the present invention. There are several commercial predictive analytic tools (namely, software packages) which can be modified to work with the present invention.

In a preferred embodiment, method 10 is used to identify the top or foremost professional performing a particular service within a given professional field. As one example, method 10 is used not simply to identify the best plastic surgeons, but rather identifies the best plastic surgeons performing a particular medical procedure. The best plastic surgeons include the top surgeons performing face lifts, nose surgeries, bone grafts, breast implants, reshaping of the abdomen, and the like. Method 10 is advantageously used by consumers to select a particular professional to perform an identifiable service for the consumer, it being understood that method 10 does not guarantee the services being performed. Method 10 can be applied to any profession in which professionals perform a specific procedure or provide particular service within the field of profession.

While the invention has been described in connection with certain preferred embodiments, those of ordinary skill in the art may recognize that the method described herein can be modified into alternative embodiments in a manner that falls within the intended scope of the invention. Those of ordinary skill in the art may also recognize that the detailed embodiments of the invention are illustrative only and should not be taken as limiting the scope of the invention.

The specialized computer apparatus that is one form of implementing the invention may be implemented in different forms, devices, and hardware within the spirit and scope of the following claims and equivalents thereto.

We claim:

1. A system and method for use with a programmable processing device for identifying the foremost professionals within a given profession, wherein the processing device comprises a processor, an input and output device, a storage device and an interactive user display, the method comprising:
Creating a solicitation board for purpose of soliciting nominations of individuals working within the given profession, the solicitation board comprising at least one individual member,
Developing criteria for use in reviewing attributes of nominations received by the solicitation board relative to attributes of a hypothetical professional working in the given field,
Reviewing the nominations relative to criteria to form a first tier of candidates, whereby the first tier of candidates are selected relative to a weighted scoring system and a pre-determined minimum score required to be achieved by each candidate,
Forming a second tier of candidates from the first tier of candidates, wherein the second tier of candidates is formed by a review of criteria and additional background information developed relative to each candidate,
Soliciting self-assessments from each of the second tier of candidates,
Soliciting objective data and information for each candidates relative to information obtained in response to surveys of individuals who received services from and who have worked with the candidates,
Creating a review board to select a third tier of candidates from the second tier of candidates, wherein the review board reviews criteria, the additional background information, the objective data and information relative to each candidate under review,
Conductors conduct independent research to develop a comprehensive valuation of the background, skills, training, and performance of each of the second tier of candidates, and
Selecting the final candidates based to form a list of the professionals having superior skills, training, and experience in the given profession.

2. The method as claimed 1, wherein the criteria comprises discrete categories of factors in which to measure part of the performance of the nominee.

3. The method as claimed in claim 1, wherein the criteria is stored in a computer in a modifiable form to identify specific qualities that potential nominees should possess.

4. The method as claimed in claim 1, wherein the solicitation board uses a survey of staff members related to the nominee to solicit views of the work habit of the nominee, including opinions.

5. The method as claimed in claim 1, wherein the solicitation board targets senior level professionals who know of the candidate to solicit information to evaluate the candidate's skills, principles, consistence and overall attitude toward his or her clients.

6. A programmable processor device for use in identifying the foremost professionals within a given profession, wherein the processing device comprises a processor, an input and output device, a storage medium, and application software designed implement a method to assist a user in identifying the foremost professionals in a given field, the method comprising:
Creating a solicitation board for purpose of soliciting nominations of individuals working within the given profession, the solicitation board comprising at least one individual member to use the programmable processor device,
Developing criteria for use in reviewing attributes of nominations received by the solicitation board relative to attributes of a hypothetical professional working in the given field, the criteria including opinions of third parties who have had professional experiences with the nominees,
Reviewing the nominations relative to criteria to form a first tier of candidates, whereby the first tier of candidates are selected relative to a weighted scoring system and a pre-determined minimum score required to be achieved by each candidate,
Forming a second tier of candidates from the first tier of candidates, wherein the second tier of candidates is formed by a review of criteria and additional background information developed relative to each candidate,
Soliciting self-assessments from each of the second tier of candidates,
Soliciting objective data and information for each candidates relative to information obtained in response to surveys of individuals who received services from and who have worked with the candidates,
Creating a review board to select a third tier of candidates from the second tier of candidates, wherein the review board reviews criteria, the additional background information, the objective data and information relative to each candidate under review,
Conductors conduct independent research to develop a comprehensive valuation of the background, skills, training, and performance of each of the second tier of candidates based on objective and subjective attributes used to measure the qualities of each candidate, the attributes being retrievably stored in a searchable database, and
Selecting the final candidates based to form a list of the professionals having superior skills, training, and experience in the given profession based on the application of the independent research.
